(19) United States
(12) Patent Application Publication
(10) Pub. No.: US 2012/0144084 A1
(43) Pub. Date: Jun. 7, 2012

(54) DATA MANAGEMENT DEVICE AND METHOD THEREOF

(75) Inventor: HONG-RU ZHU, Shenzhen (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/013,817

(22) Filed: Jan. 26, 2011

(30) Foreign Application Priority Data
Dec. 3, 2010 (CN) 201020640988.5

(51) Int. Cl. G06F 13/38; G06F 1/26

(52) U.S. Cl. 710/305

(57) ABSTRACT

A data management device used to manage (that is, exchange data, upgrade programs, and other tasks) a communication device includes a microprocessor unit (MPU), a communication module, a storage module, a display module, and an input/output module. The communication module, the storage module, the display module, and an input/output module are connected to the MPU. The communication module establishes communication between the MPU and the communication device. The storage module stores driver and application programs for the MPU. The display module displays communication states between the MPU and the communication device. Management information can be input into the MPU by the input/output module and transmitted to the communication device by the communication module.

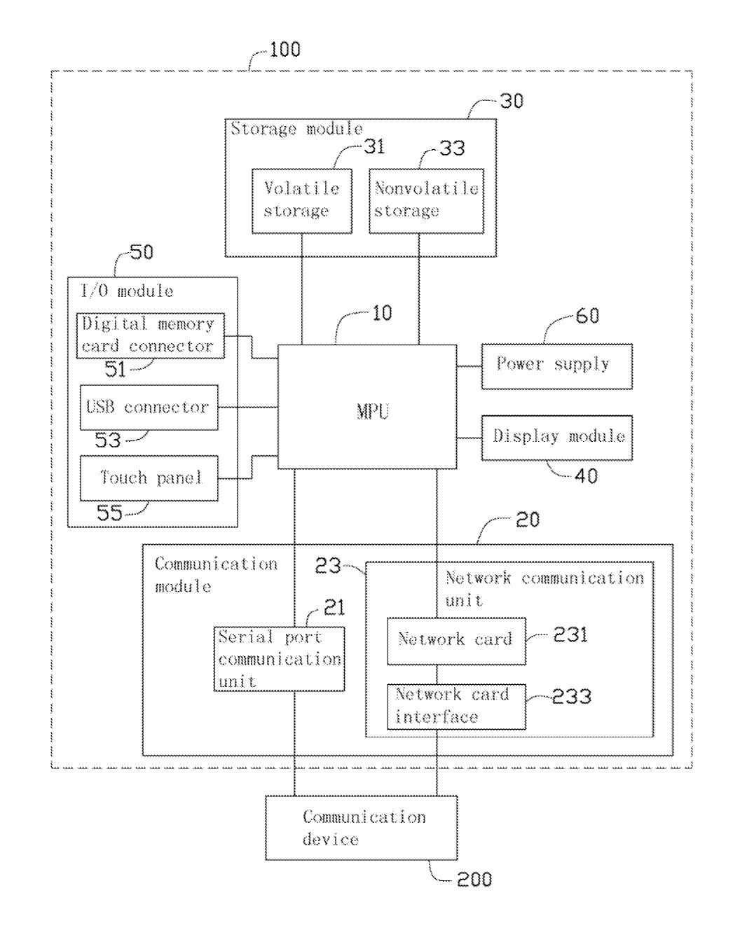

### BACKGROUND

1. Technical Field

The disclosure generally relates to data management, and particularly to a data management device and a data management method of the communication device.

2. Description of Related Art

To manage computers or servers in a network, an extra computer is often imported into the network. However, this is physically and logistically inconvenient and increases management costs. Therefore, it is necessary to provide a miniaturized and simplified data management device.

Therefore, there is room for improvement within the art.

### BRIEF DESCRIPTION OF THE DRAWINGS

Many aspects of the data management device and method thereof can be better understood with reference to the following drawings. The components in the drawings are not necessarily drawn to scale, the emphasis instead being placed upon clearly illustrating the principles of the data management device and method thereof.

The drawing is a block diagram of a data management device, according to an exemplary embodiment.

### DETAILED DESCRIPTION

The drawing shows a data management device 100 which can be used to manage (that is, exchange data, upgrade programs, and other tasks) a communication device 200 such as a computer or a server, according to an exemplary embodiment.

The data management device 100 includes a microprocessor unit (MPU) 10, a communication module 20, a storage module 30, a display module 40, an input/output (I/O) module 50 and a power supply 60. The communication module 20, the storage module 30, the display module 40, the I/O module 50 and the power supply 60 are electronically connected the MPU 10.

The MPU 10 controls operation of the communication module 20, the storage module 30, the display module 40 and the I/O module 50.

The communication module 20 establishes communication between the communication device 200 and the data management device 100. The communication module 20 includes a serial port communication unit 21 and a network communication unit 23. The serial port communication unit 21 may be a universal asynchronous receiver/transmitter (UART). The interwork communication unit 23 establishes communication between the communication device 200 and the data management device 100 by a local area network (LAN). The network communicate unit 23 includes a network card 231 and a network card interface 233 connected to the network card 231. In this embodiment, network card 231 can be a DM9000, and the network card interface 233 can be an RJ-45 interface.

The storage module 30 stores driver and application programs for the MPU 10. The storage module 30 includes volatile storage 31 and nonvolatile storage 33. In this embodiment, the volatile storage 31 can be synchronous dynamic random access memory (SDRAM) and the non volatile storage 33 can be flash memory or electrically erasable programmable read only memory (EEPRAM).

The display module 40 is a display that is configured to display communication states between the data management 100 and the communication device 200.

The I/O module 50 includes a digital memory card (such as a secure digital memory card) connector 51, a universal serial bus (USB) connector 53, and a touch screen 55. The SD connector 51 can receive a memory card. The USB connector 53 provides connection of a peripheral element such as a keyboard, mouse or a USB flash memory device.

The power supply 60 may be a battery providing power to the MPU 10.

In use, communication is established between the data management device 100 and the communication device 200 by the communication module 20. Management information such as commands, data or other files can be input into the data management device 100 by the touch screen 55 or a keyboard connected through the USB connector 53, or conveyed to the data management device 100 on a SD card or in a USB storage device respectively received in the SD card connector 51 or USB connector 53. The data management device 100 provides the management information to the communication device 20 to support management thereof.

The data management device 100 uses a MPU 10 to replace a center processor unit (CPU) and has a minimized volume and management costs.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A data management device used to manage a communication device, the data management device consisting of:
a microprocessor unit (MPU);
a communication module electronically connected to the MPU, and establishing a communication between the MPU and the communication device;
a storage module electronically connected to the MPU, the storage module for storing driver and application programs for the MPU;
a display module electronically connected to the MPU, the display module displaying communication states between the MPU and the communication device; and
an input/output module electronically connected to the MPU; wherein management information can be input into the MPU by the input/output module and transmitted to the communication device by the communication module.

2. The data management device as claimed in claim 1, further comprising a power supply connected to the MPU, the power supply provides electrical power to the MPU.

3. The data management device as claimed in claim 2, wherein the power supply is a battery.

4. The data management device as claimed in claim 1, wherein the input/output module includes a touch screen and a universal serial bus connector.

5. The data management device as claimed in claim 4, wherein the input/output module further includes a digital memory card connector.

7. The data management device as claimed in claim 1, wherein the communication module includes a serial port communication unit and a network communication unit.

8. The data management device as claimed in claim 7, wherein the serial port communication unit is a universal asynchronous receiver/transmitter.

9. The data management device as claimed in claim 7, wherein the interwork communication unit establishes a communication between the communication device and the data management device by a local area network

10. The data management device as claimed in claim 1, wherein the storage module includes volatile storage and nonvolatile storage.

11. The data management device as claimed in claim 1, wherein the volatile storage is synchronous dynamic random access memory.

12. The data management device as claimed in claim 1, wherein the non volatile storage is flash memory or electrically erasable programmable read only memory.

13. A data management method for managing a communication device; comprising:
providing a data management device;
establishing a communication between the data management device and the communication device;
displaying communication states between the data management device and the communication device on a display module;
inputting management information into the data management device;
transmitting the management information to the communication device to manage the communication device from the data management device.
